(19) United States
(12) Patent Application Publication
(10) Pub. No.: US 2006/0229048 A1
(43) Pub. Date: Oct. 12, 2006

(54) Remote control of antenna line devices

(76) Inventors: Niallo Donal Carroll, Dublin (IE); Fergal Joseph Lawlor, County Laois (IE)

Correspondence Address: BARNES & THORNBURG, LLP, P.O. BOX 2786, CHICAGO, IL, 60690-2786, US

(21) Appl. No.: 11/286,655

(22) Filed: Nov. 23, 2005

(30) Foreign Application Priority Data
Nov. 24, 2004 (GB) 0425813.3

(51) Int. Cl. H04B 1/04; H04B 1/16; H04M 1/00

(52) U.S. Cl. 455/268; 455/575.7; 455/121

(57) ABSTRACT

A control means for controlling an antenna line device (6) in a radio telecommunications network in response to an input control signal has a plurality of possible modes of operation, in each of which the control means (26) is operable to receive, decode and implement the control signals in accordance with a respective protocol, and includes mode selection means (26) for selecting a mode of operation from a plurality of said modes. The control means can form part of the beam direction control apparatus (6) for an antenna, which itself can be connected to a base station of a mobile telecommunications system.

### FIELD OF THE INVENTION

This invention relates to control means for controlling an antenna line device, antenna beam direction control apparatus having such control means and to an antenna having such beam direction control apparatus.

### BACKGROUND TO THE INVENTION

An antenna line device of a mobile telecommunication system is generally located in the vicinity of a base station of the system and can be used to control an operating parameter of an antenna connected to the base station. One example of such a device is an antenna phase shifter. This is generally an electrical or electromechanical device that alters the relative phase of signals transmitted or received by the elements of the antenna, thereby to provide control of the antenna's beam tilt. Other examples of antenna line devices include a mast head amplifier for amplifying the signals received by an antenna before those signals are relayed to the base station, and a booster amplifier for amplifying transmitted signals.

In the field of mobile telecommunications networks, there is an increasing adoption of remotely controllable antenna line devices, in particular devices for altering the beam tilt and mast head amplifiers. Various ways of achieving such control have been developed. Although there has been some convergence in the implementations, due to the influence of bodies and organisations such as AISG and 3GPP, there is still no clearly defined open and universally accepted standard protocol for the control signals for the antenna line devices.

Thus, one communications protocol has been developed by AISG to control electrical parameters of antenna line standards (known as the Antenna Interface Standards Group Standard No. AISG 1 version 1.1), whilst 3GPP have defined another draft protocol for remote control of electrical tilt of antennas and other proprietary protocols have been developed by telecommunications infrastructure and antenna manufacturers (for example the Ericsson RET Remote Electrical Tilt) control protocol). Each of these protocols requires a respective dedicated control means (or module) for converting the control signals received from the base station into outputs that cause the required control of the antenna line devices.

### SUMMARY OF THE INVENTION

According to a first aspect of the invention, there is provided control means for controlling an antenna line device in a radio telecommunications network in response to an input control signal, wherein the control means has a plurality of possible modes of operation, in each of which the control means is operable to receive, decode and implement the control signals in accordance with a respective protocol, and includes mode selection means selecting a mode of operation from a plurality of said modes.

Thus, a single control means, can be used with systems which provide control signals in any one of a number of possible protocols. Consequently, the control means is compatible with a plurality of different standards.

Preferably, the control means is operable to control an antenna line device comprising direction control apparatus for altering the beam pattern or direction, preferably the beam tilt, of an antenna.

Preferably, the control means is operable to control a phase shifter for adjusting antenna beam tilt.

Preferably, the control means is operable to control an electromechanical phase shifter having a motor, the control means having an output for a drive signal for the motor.

Additionally, or alternatively, the control means may be operable to control an local amplifier (such as a mast head amplifier) for an antenna, the control means having an output for a gain control signal for the amplifier.

Preferably, the control means has an input and an output for said control signals so that a plurality of such control means can be connected together in a serial signal bus, if the signalling protocol permits serial connection of the control means.

Where the control means has a port in addition to an input port, the mode selection means may to advantage comprise means responsive to the resistance detected at the additional port.

Preferably the additional port comprises said outlet.

Thus the required operating mode can be determined from the resistance of a load (if any) connected to said output.

The mode selection means may be operable to determine in which of a plurality of resistance bands, each associated with a respective mode, said resistance falls, and to select the mode accordingly.

Additionally or alternatively, the mode selection means may be operable to determine whether there is a short circuit of the additional port and to select a first mode if there is such a short circuit and a second mode otherwise.

This feature is particularly useful when the control means is operable to receive signals in either of two protocols, one of which permits a succession of said control means to be connected together in a serial bus. In such a case, that mode can be selected simply by connecting the output ports of each control means to the input port of the next control means in the path of the signal bus and leaving the output port of the last control means unconnected, i.e. in an open circuit condition. This results is no short circuit being detected at any of the outputs and in the correct mode of operation of the control means automatically being selected.

The other mode is selected by connecting a respective short circuit termination element to the output of the control means. If the base station has a plurality of antenna line devices, each controlled by a respective control means, then, when functioning in this mode, the input of each control means is connected to the base station via a respective signal line, and the output of the control means is terminated by a respective short circuit termination element.

Preferably, the first said mode corresponds to the AISG protocol and/or the second mode corresponds to the Ericsson protocol.

According to a second aspect of the invention, there is provided beam direction control apparatus for an antenna of a mobile telecommunications network, the apparatus comprising control means as herein above described connected to beam adjustment means for altering said beam direction.

Preferably, the beam adjustment means comprises a phase shifter, preferably electromechanical phase shifter.

The invention also lies in a base station from mobile telecommunications system, having associated beam direction control apparatus as herein above described and an antenna connected thereto.

### BRIEF DESCRIPTION OF THE DRAWINGS

The invention will now be described, by way of example only, with reference to the accompanying drawings in which:

FIG. 1 is an exploded perspective view of an antenna assembly in accordance with the invention;

FIG. 2 is an block diagram of the antenna assembly;

FIG. 3 is a perspective view of part of the antenna assembly, the view showing various inputs and outputs for the assembly,

FIG. 4 is a diagrammatic view of three such assemblies connected together in such a way as to select a first mode of operation, the figure also showing various devices from which control signals can be sent to the assemblies;

FIG. 5 shows an antenna assembly connected to a mast head amplifier of a base station in such a way that a second mode of operation is selected;

FIG. 6 is an exploded perspective view of a radiating patch sub-assembly of the antenna assembly, and

FIG. 7 is a diagram representing the various pins of the male and female connections for connecting the antenna assembly to a base station.

### DETAILED DESCRIPTION

The antenna assembly shown in FIG. 1 comprises an aluminium base plate 1 on which a dual polarisation radiating patch assembly 2 is mounted via dielectric spacer elements 4 so as to define a space between the plate 1 and assembly 2. That space accommodates a phase shifter 6, a servo-motor 8 and control means 10 comprising a control board mounted in a conductive housing. The control means controls the operating of the motor 8 which, in turn, operated the phase shifter 6.

The plate 1, radiating patch assembly 2 and the components accommodated between those two elements are all contained within an elongate radome 12 which is open at both ends to allow the contained components to be inserted or removed from the radome, and which, in use, is closed at its top by a protective cap 14. The radiating patch assembly 2 is of the kind currently sold by the present applicants, and is substantially as described in their UK Patent specification No. GB 2364175B. The assembly thus comprises a linear array of radiating patch sub-assemblies, for example assembly 16, mounted via dielectric spacers on a panel 18, the upper surface of which is coated in copper and the lower surface of which has a feed/reception network of transmission lines connecting each patch sub-assembly to a respective feed port on the phase shifter 6.

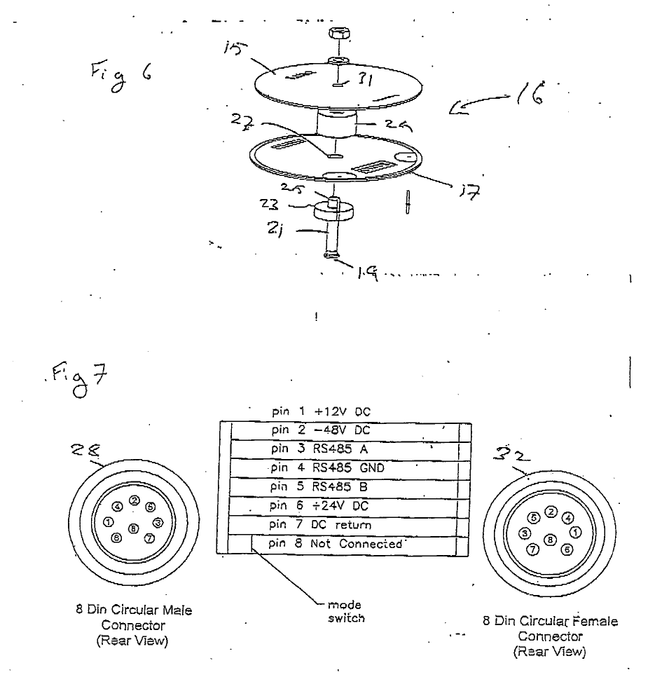

With reference to FIG. 6, each patch assembly comprises an upper circular and a panel 15 lower circular panel 17 which are held in spaced parallel relationship with each other.

A threaded stud 19 extends from the board 18. A dielectric spacer 21, having a flange-like support number 23, is threaded onto the stud 19. A central shaft 25 extends through a central aperture 27 in the feed panel 17, which rests on the member 23. A second dielectric spacer 29 separates the panel 17 from the panel 15 and includes a central passage through which the shaft 25 extends so that the upper end of the shaft protrudes through a central aperture 31 in the panel 15, the protruding end of the shaft 25 being secured to a nut for fastening the elements of the assembly together. It will be appreciated that the shaft 25 in FIG. 6 has been depicted as being shorter than it actually is.

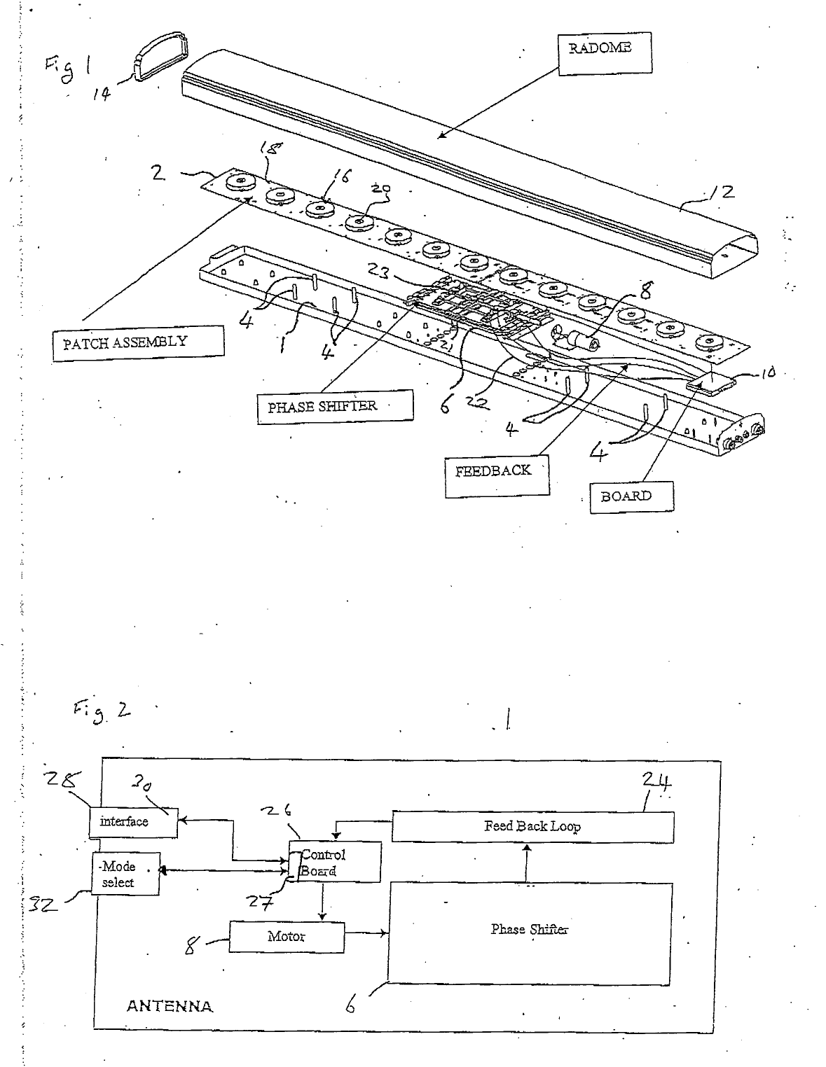

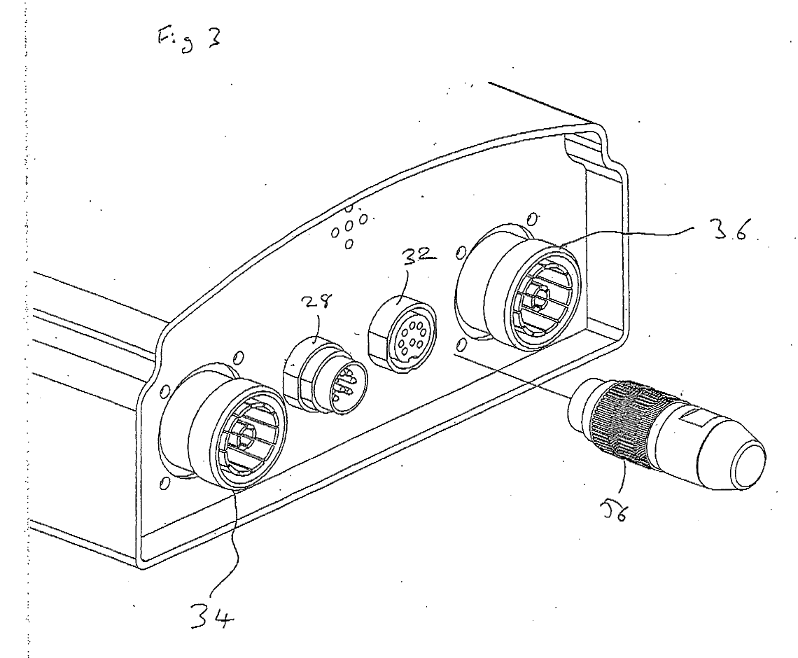

The phase shifter assembly 6 comprises a pair of microstrip antenna phase shifters one for each respective polarity of signals sent/received by the radiating patch assembly 2. The relative phases of signals of the input/output ports of the phase shifter assembly are controlled by means of a common dielectric slider 21 which is slideably mounted between the two phase shifters and is connected to the motor 8 by means of a worm drive 23. The linear position of the slider and the angular position of the output shaft of the motor 8 are monitored by means of an opto-electronic feedback system. The feedback system uses a series of LEDs and photo transistors in the housing 10 which are connected to the phase shifter assembly 6 by means of fibre optic cables, for example, cable 22. In FIG. 2, the feedback system is generally indicated by the block 24. The form and function of the phase shifter assembly 6, motor 8 and feedback system 24 are as described in the applicant's existing PCT Patent Application No. PCT/EP2004/006054, the contents of which are incorporated herein by reference.

The housing 10 also contains a control means in the form of control board 26 (FIG. 2) which is connected to a control signal input port 28, comprising an eight pin connector 30. The control board 26 is configured to receive control signals through the port 28 in either of two signalling protocols, depending upon the mode of operation of the control board 26, and to convert those signals into control signals for operating the servo-motor 8.

The control board is also connected to the feedback system 24 and uses signals from the latter to determine the angular displacement of the output shaft of the motor 8 and the linear displacement of the dielectric slider 21. The feedback signals are therefore used in conjunction with control signals to cause the motor 8 to move the dielectric slider 21 to a desired position to achieve a desired beam tilt for the array of radiating patches of the radiating patch assembly 2.

The control board 26 is also connected to an output port 32. Where the control board is connected in a serial signal (RS485) bus to a plurality of other like control boards, the output port 32 provides an output for control signals for other control boards relayed via the board 26. The board 26 has a microchip PIC 18F micro-controller 27 having an analogue input connected to the port 32 in such a way that any load on the port 32 creates a potential divider between the AISG power supply and any resister attached between the analogue input pin and the zero volts pin on the AISG connector (i.e. pin Nos. 7 and 8 on connectors 32 and 28). This potential divider allows the micro-controller firmware to read the value of a resistor placed between the analogue input pin and the zero volt terminal [pin No. 7] with a high degree of accuracy. Up to ten different finite, non zero resistor values can, in theory, be accurately determined along with open circuit (no resistor) or short circuit (jumper wire attached) conditions. Thus the micro-controller can read up to 12 resistance values.

The system conforms to the OSI Basic Reference Model which sets out 7 layers:
1) The Physical Layer describes the physical properties of the various communications media, as well as the electrical properties and interpretation of the exchanged signals. Ex: this layer defines the size of Ethernet coaxial cable, the type of BNC connector used, and the termination method.
2) The Data Link Layer describes the logical organisation of data bits transmitted on a particular medium. Ex: this layer defines the framing, addressing and checksumming of Ethernet packets.
3) The Network Layer described how a series of exchanges over various data links can deliver data between any two nodes in a network. Ex: this layer defines the addressing and routing structure of the Internet.
4) The Transport Layer describes the quality and nature of the data delivery. Ex: this layers defines if and how retransmissions will be used to ensure data delivery.
5) The Sessions Layer describes the organisation of data sequences larger than the packets handled by lower layers. Ex: this layer describes how request and reply packets are paired in a remote procedure call.
6) The Presentation Layer described the syntax of data being transferred. Ex: this layer describes how floating point numbers can be exchanged between hosts with different math formats.
7) The Application Layer described how real work actually gets done. Ex: this layer would implement file system operation.

The processor has loaded into it a low level (level 2) communications stack which can be High Level Data Link Control (HDLC) or similar. This can support numerous application layer (layer 7) protocols, which are fully documented in Antenna Interface Standards Group standard No. AISG 1 version 1.1). The commands that the control board 26 is responsive to and the procedure that it can undertake are implemented on the application layer depending upon what is required or specified in the instructing signals. Thus the controller can interpret and implement instruction signals (received through the port 28) in accordance with the AISG protocol.

At power up, the firmware of the micro-controller reads the resistance at the analogue input of the port 32 and compares the value against a jump table. Based on the table, the code jumps to the appropriate line of code in the programme stored in the microcontroller. In each mode, the code shares common functions but the core level 7 code is unique to each respective mode.

If the firmware detects an open circuit at the analogue input pin, the micro-controller jumps to a mode of operation in which it can deal with AISG protocol signals. If, however, a short circuit is detected, the micro-controller jumps to a mode in which the Ericsson protocol can be handled. Thus the microcontroller 27 acts as a mode selector.

The antenna assembly also includes two RF input/output ports 34 and 36 which are, in use, connected to a base station through RF feeder cables. The ports 34 and 36 are also connected to the input/output terminals of the phase shifter assembly 6.

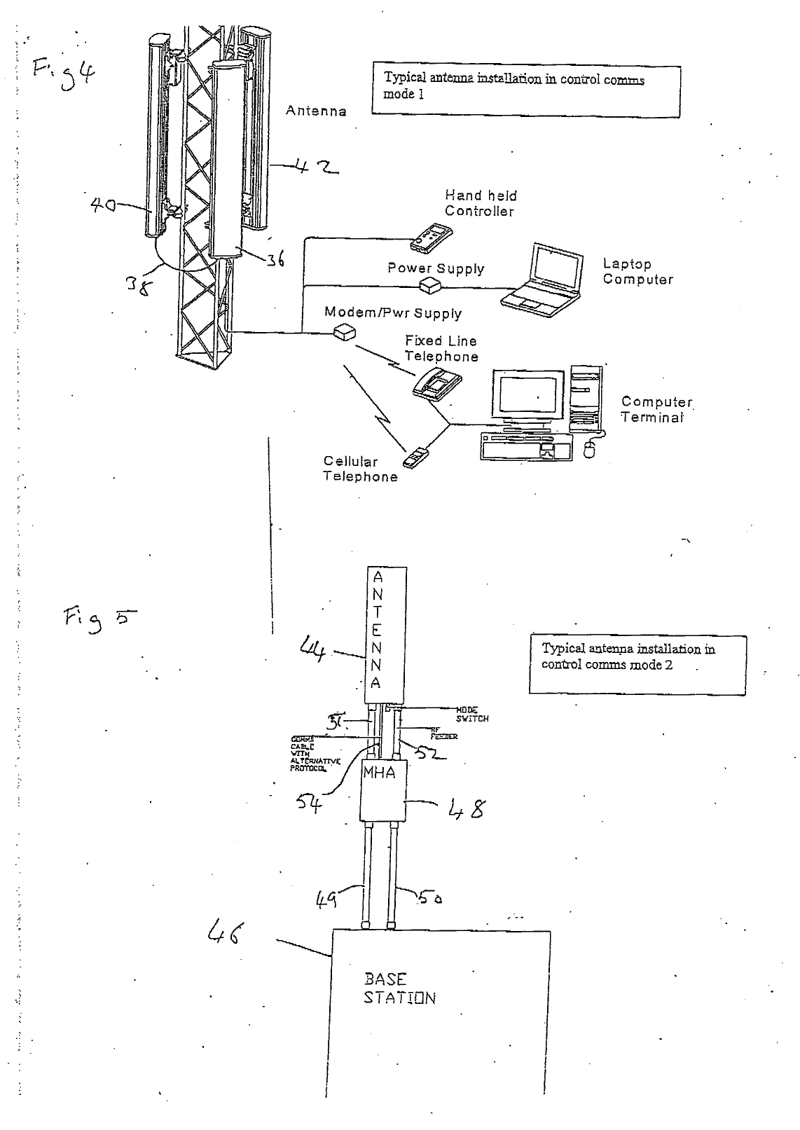

In FIG. 4, the antenna assembly is one of three such assemblies which are connected together on a serial control bus. Thus the input port 32 of the assembly 36 is connected to a source of control signals, whilst the output port 32 is connected via a cable 38 to the input port 28 of the second antenna assembly 40. The port 32 of the assembly 40 is connected to the port 28 of a third assembly 42 and the 32 of the assembly 42 is left open circuit. On power up, the firm ware of the micro-controllers in the three antenna assemblies determine the resistances at the analogue pins of their respective ports 32, more specifically determine that those resistances are non-zero since none of the pins is short circuited. Consequently, all three micro-controllers jump to the code which causes the micro-controllers to operate in accordance with the AISG protocols.

All three antenna assemblies are connected to a common base station (not shown) through a respective mast head amplifier (not shown).

As can be seen from FIG. 4, the control signals for the phase shifters can be produced by any one of a number of possible devices. The sources of the communications will be a control programme can run on any capable device lap top pda, server etc. The link between the controlling programme and the device can be many different forms. Various routers interface boxes and modems may be required to transform the comms into suitable formats to travel on the next link of the network, fixed line wireless or otherwise.

The power supply's function is to provide the do current to drive the phase shifter actuation, there is no such power available from the pc the source of the 485 coms

The arrangement shown in FIG. 5 is intended for use with the Ericsson protocol, and has an antenna assembly 44 connected to a base station 46 via a Mast Head Amplifier 48 and RF feeder cables 49-52. In this case, antenna beam tilt signals can be received by the base station over the operations and maintenance network of the mobile telecommunications network itself. The base station can separate the signals and feed them to the mast head amplifier 48 which then relays those signals along a cable 54 to the port 28 of the antenna assembly 44. The port 32 of the assembly is connected to a termination piece 56 (FIG. 3) which provides a short circuit between the analogue input pin and the zero volts rail so that, on power up, the firmware of the micro-controller of the control board 26 detects a resistance of zero at the analogue pin. This, in turn, causes the code jump which results in the micro-processor operating in accordance with the Ericsson protocol of signals.

In order to conserve memory and other hardware resources, the codes programmed into the micro-controller on the board 26 can share certain common procedures and low level hardware functions. All level 1 and most level two communications code is the same. The main functions such as calbrate, set tilt, and get tilt are the same. The main differences relate to how the devices are addressed, what data and what parameters can be accessed and stored, the scope of the commands available and how the commands are presented to the end user or system.

1. Control apparatus for controlling an antenna line device in a radio telecommunications network in response to an input control signal, wherein the control apparatus has a plurality of possible modes of operation, in each of which the control apparatus is operable to receive, decode and implement the control signals in accordance with a respective protocol, and includes a mode selector for selecting a mode of operation from a plurality of said modes.

2. Control apparatus according to claim 1, in which the control apparatus is operable to control an antenna line device comprising direction control apparatus for altering the beam pattern or direction of an antenna.

3. Control apparatus according to claim 2, in which the control apparatus is operable to control a phase shifter for adjusting antenna beam tilt.

4. Control apparatus according to claim 3, in which the control apparatus is operable to control an electromechanical phase shifter having a motor, the control apparatus having an output for a drive signal for the motor.

5. Control apparatus according to claim 1, in which the control apparatus is operable to control a local amplifier for an antenna, the control apparatus having an output for a gain control signal for the amplifier.

6. Control apparatus according to claim 5, in which the control apparatus is operable to control a mast head amplifier.

7. Control apparatus according claim 1, in which the control apparatus has an input port and output port for said control signals so that a plurality of such control apparatuses can be connected together in a serial signal bus, if the signalling protocol permits said serial connection of the control means.

8. Control apparatus according to claim 1, in which the control apparatus has an input port and an additional port, the mode selector being responsive to the resistance detected at the additional port.

9. Control apparatus according to claim 8, when appended to claim 7, in which the additional port comprises said outlet.

10. Control apparatus according to claim 8, in which the mode selector is operable to determine in which of a plurality of resistance, each associated with a respective mode, said resistance falls, and to select the mode accordingly.

11. Control apparatus according to claim 8, in which the mode selector is operable to determine whether there is a short circuit of the additional port and to select a first mode if there is such a short circuit and a second mode otherwise.

12. Control apparatus according to claim 11, in which the first said mode corresponds to the AISG protocol and/or the second mode corresponds to the Ericsson protocol.

13. Beam direction control apparatus for an antenna of a mobile telecommunications network, the apparatus comprising control apparatus according to claim 1 connected to beam adjustment apparatus for altering the said beam direction.

14. Apparatus according to claim 13, in which the beam adjustment apparatus comprises a phase shifter.

15. Apparatus according to claim 14, in which the phase shifter is an electromechanical phase shifter.

16. A base station for a mobile telecommunications system, having associated beam direction control apparatus according to any of claim 13 and an antenna connected thereto.
